(19) United States
(12) Patent Application Publication
(10) Pub. No.: US 2024/0279939 A1
(43) Pub. Date: Aug. 22, 2024

(54) FLEXIBLE AUTOMATED PRODUCTION OF THREE-DIMENSIONAL PRINTED BUILDING ELEMENTS

(71) Applicant: Mighty Buildings, Inc., Oakland, CA (US)

(72) Inventors: Aleksei Dubov, San Mateo, CA (US); Ilya Lipatov, Moscow (RU); Sergey Pshenichnikov, Santa Catarina (MX); Anton Shchepelin, Monterrey (MX); Anton Zriashchev, Santa Catarina (MX)

(21) Appl. No.: 18/112,825

(22) Filed: Feb. 22, 2023

(51) Int. Cl. E04G 21/04; E04G 21/06

(52) U.S. Cl. CPC E04G 21/04; E04G 21/06; B33Y 10/00; B33Y 30/00; B33Y 40/20; B33Y 50/02

(57) ABSTRACT

A system for manufacturing 3D-printed building elements can include multiple production stations, some or all of which can be automated stations. Stations can include one or more printing stations, insulation stations, machining stations, and coating stations. Each printing station can have a large-scale 3D-printing system that automatically forms 3D-printed building elements. Each insulation station can automatically place insulation materials into 3D-printed building elements. Each machining station can automatically machine surfaces of 3D-printed building elements. Each coating station can automatically apply coating layers onto 3D-printed building elements. Each station can be configured to receive 3D-printed building elements in a vertical orientation from other stations and can also perform operations on 3D-printed building elements while they are in a vertical orientation. Additional stations can include relaxation, drying, and framing stations.

### TECHNICAL FIELD

The present disclosure relates generally to three-dimensional (“3D”) printing, and more particularly to the manufacturing of 3D-printed building elements.

### BACKGROUND

Prefabricated construction (“prefab”) is becoming increasingly popular, as it involves manufacturing building elements in a factory and then transporting those building elements to a construction site to be used to create a finished building. Traditional prefab builders produce wood-frame panels and other building elements using subtractive methods of manufacturing that can result in inefficiencies, huge labor requirements, and large amounts of waste. Manufacturing prefab panels often requires many steps, since individual parts tend to be cut to size, slotted, drilled, and then assembled into the panels. This results in long production lines that include multiple-step assembly and finishing operations that are often manually performed. Panels under production often move lying horizontally, which requires extra space for such movement.

Concrete can also be used in construction to make prefabricated parts, although the surfaces of prefab concrete elements are typically unfinished and are very rough. Prefabricated concrete elements are usually finished on-site, which can be costly. In addition, concrete prefabricated elements can require 8-12 hours or more under certain conditions within a factory and several days outside of the factory for curing. This affects the required space for the factory operation. Since traditional prefabrication processes are multi-step operations, such operations often require many manual laborers and/or multiple machines with specialized operators, and a single operator typically cannot operate more than one machine due to far distances between machines. As a result of these various factors, traditional prefab construction companies often require large facilities with over 100,000 square feet per production line, many equipment items for each production operation or function, and many operators.

Accordingly, traditional prefab factories for wood, steel, and concrete building elements unfortunately require large amounts of facility space for manufacturing building elements, large amounts of warehouse space to store raw materials, and large amounts of manual and skilled labor. Due to large facility space requirements, such factories are usually located far from main labor pools and urban areas. The large amounts of space required for typical traditional prefab factories also tend to result in higher real estate and utility costs. Also, the need to have such large prefab factories established before any operations can take place often results in a lack of flexibility or scalability if construction needs or desires change in the future. Any needed expansions to such factories then tend to be inefficient if not impossible.

Although traditional ways of manufacturing prefabricated building elements have worked well in the past, improvements are always helpful. In particular, what is desired are flexible, efficient, and scalable manufacturing systems that can produce a robust variety of prefabricated building elements within a compact amount of space.

### SUMMARY

It is an advantage of the present disclosure to provide flexible, efficient, and scalable manufacturing systems that can produce a robust variety of prefabricated building elements within a compact amount of space. The disclosed features, apparatuses, systems, and methods provide improved ways for manufacturing prefab building elements and for designing factories for such manufacturing endeavors. These advantages can be accomplished in multiple ways, such as by utilizing large scale 3D-printing systems to form 3D-printed prefab building elements, as well as optimizing and arranging production stations for various production functions in an overall manufacturing process such that a variety of different 3D-printed building elements can be manufactured in an efficient manner regardless of which production functions are needed for each different 3D-printed building element. Production space can be reduced in a variety of ways, such as by arranging stations and transports therebetween so that all production functions and transports can be conducted with 3D-printed building elements in a vertical orientation.

In various embodiments of the present disclosure, a system for manufacturing 3D-printed building elements can include at least one printing station, at least one insulation station, at least one machining station, and at least one coating station. Each printing station can have a large-scale 3D-printing system configured to automatically form 3D-printed building elements. Each insulation station can be configured to automatically place one or more insulation materials into the 3D-printed building elements. Each insulation station can be further configured to receive the 3D-printed building elements in a vertical orientation from each printing station. Each machining station can be configured to automatically machine one or more surfaces of the 3D-printed building elements to facilitate future coupling of the 3D-printed building elements to other building elements or building parts. Each machining station can be further configured to receive the 3D-printed building elements in a vertical orientation from each printing station and from each insulation station. Each coating station can be configured to automatically apply one or more coating layers onto the 3D-printed building elements. Each coating station can be further configured to receive the 3D-printed building elements in a vertical orientation from each printing station, from each insulation station, and from each machining station.

In various detailed embodiments, the system can further include at least one relaxation station configured to automatically facilitate hardening of the 3D-printed building elements after the 3D-printing process. Each relaxation station can be further configured to receive the 3D-printed building elements in a vertical orientation from each printing station. The system can also include at least one drying station configured to automatically facilitate drying of one or more coating layers applied by a coating station to the 3D-printed building elements. Each drying station can be further configured to receive the 3D-printed building elements in a vertical orientation from a coating station. Each coating station can be further configured to automatically facilitate drying of one or more coating layers applied by the coating station to the 3D-printed building elements. In some arrangements, the system can be contained within a manufacturing production line and the footprint of the manufacturing production line can be less than about 15,000 square feet. Also, each of the stations can be further configured to perform its respective function on the 3D-printed building elements while the 3D-printed building elements are in a vertical orientation.

In further detailed embodiments, each printing station can include a robotic or gantry based subsystem configured to automatically 3D-print and cure base portions of the 3D-printed building elements layer-by-layer using a photo-curable material. Each insulation station can include a robotic subsystem configured to automatically inject polyurethane insulation foam into one or more cavities within the 3D-printed building elements. Each machining station can include a robotic subsystem configured to automatically machine the one or more surfaces of the 3D-printed building elements. Each coating station can include a robotic subsystem configured to automatically apply different types of coating materials onto the 3D-printed building elements. In some arrangements, at least a portion of the stations can be configured to have no more than one 3D-printed building element therein at a time. In some arrangements, at least a portion of the stations can be configured to have multiple 3D-printed building elements therein at a time. In various embodiments, at least one of the stations can have a longer production cycle than the production cycle of another one of the stations, and the system can include multiple stations of the same type as the station having the longer production cycle. At least a portion of the stations can use the same type of interchangeable robotic systems, and a production process within the system can be changed by rerouting a production flow of the 3D-printed building elements through at least a portion of the stations using the same type of interchangeable robotic systems.

In still further detailed embodiments, the system can include one or more scrap and rework stations configured for the scrapping and reworking of materials within the system. Alternatively, the scrapping and reworking of materials can be handled outside of the system. The system can also include one or more automated guided vehicles configured to automatically move the 3D-printed building elements from one of the stations to another one of the stations. One or more of these automated guided vehicles can be further configured to be used as a printing base within the at least one printing station. The system can also include one or more framing stations configured for assembly of the 3D-printed building elements with additional building components. In some arrangements, each of the stations can be coupled to a separate control system and can be configured to be managed by one or more production operators. In some arrangements, all of the stations can be coupled to a unified control system and the unified control system can be configured to facilitate the supervision and control of all of the stations by one production operator. One or more of the stations can be configured to read RFID tags to identify the 3D-printed building elements. Also, arrangement of the stations can be configured by a separate CAD/CAE system where the 3D-printed building elements are designed. In some arrangements, the system can include one or more packaging stations configured for packaging the 3D-printed building elements when the 3D-printed building elements are finished. Alternatively, the system can be configured to facilitate moving finished 3D-printed building elements to a separate packaging area outside of the system.

In further embodiments of the present disclosure, methods of producing a 3D-printed building element are provided. Pertinent process steps can include printing the element, moving the element into an insulation station, placing insulation materials into the element, moving the element into a machining station, machining the element, moving the element into a coating station, coating the element, and moving the element out of the coating station. The printing can involve printing automatically the 3D-printed building element within a printing station having a large-scale 3D-printing system. The placing can involve placing automatically one or more insulation materials into the 3D-printed building element within the insulation station. The machining can involve machining automatically one or more surfaces of the 3D-printed building element within the machining station. The coating can involve applying automatically one or more coating layers onto the 3D-printed building element within the coating station.

In various detailed embodiments, further process steps can include moving the 3D-printed building element into a relaxation station and facilitating automatically hardening the 3D-printed building element within the relaxation station. Facilitating hardening can occur before moving the 3D-printed building element into the insulation station. Other process steps can include moving the 3D-printed building element into a drying station and facilitating automatically drying the one or more coating layers applied by the at least one coating station. In various arrangements, some or all of the process steps can be performed while the 3D-printed building element is in a vertical orientation.

In various further embodiments of the present disclosure, one or more non-transitory computer readable media are provided that include computer program code for simulating a production line for manufacturing 3D-printed building elements. The computer readable media can include computer program code for accepting a plurality of inputs regarding desired production metrics for the production line for manufacturing 3D-printed building elements, computer program code for analyzing the plurality of inputs using a known set of production line parameters, and computer program code for providing an output that includes an optimal configuration of the production line and the potential maximum throughput of 3D-printed building elements manufactured by the production line. The optimal configuration of the production line can include at least required numbers of printing stations, insulation stations, machining stations, and coating stations.

In various detailed embodiments, the optimal configuration of the production line can further include a required numbers of 3D-printed building element moving vehicles, 3D-printed building element stackers, quality engineers, general workers, and worker shifts per day, a required amount of power consumption, an estimated amount of generated recycling, and an estimated amount of generated scrap. Also, the plurality of inputs can include desired amounts of scrap percentage per station, rework percentage per produced 3D-printed building element, required time per produced 3D-printed building element, and maintenance downtime per station. The optimal configuration of the production line can further include an estimated carbon footprint per produced 3D-printed building element. In some arrangements, the computer readable media can further include computer program code for providing an updated output based on an updated set of production line parameters. The updated set of production line parameters can include new equipment installed to the previous optimal configuration, fewer worker shifts than in the previous optimal configuration, different amounts of downtime per station than in the previous optimal configuration, one or more material shortages, or one or more economical metrics. In some arrangements, the output can also include information regarding costs to run the production line at different production capacities.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for the flexible automated production of 3D-printed building elements. These drawings in no way limit any changes in form and detail that may be made to the disclosure by one skilled in the art without departing from the spirit and scope of the disclosure.

FIG. 1 illustrates in top plan view an example system for manufacturing 3D-printed building elements according to one embodiment of the present disclosure.

FIG. 2A illustrates in front perspective view an example simple 3D-printed building element according to one embodiment of the present disclosure.

FIG. 2B illustrates in obverse perspective view the 3D-printed building element of FIG. 2A according to one embodiment of the present disclosure.

FIG. 3 illustrates a flowchart of an example summary method of producing a 3D-printed building element according to one embodiment of the present disclosure.

FIG. 4 illustrates in block diagram format an example alternative system for manufacturing 3D-printed building elements according to one embodiment of the present disclosure.

FIG. 5 illustrates in block diagram format an example system for manufacturing 3D-printed building elements having multiple production lines according to one embodiment of the present disclosure.

FIG. 6A illustrates in front perspective view an example complex 3D-printed building element according to one embodiment of the present disclosure.

FIG. 6B illustrates in obverse perspective view the 3D-printed building element of FIG. 6A according to one embodiment of the present disclosure.

FIG. 7A illustrates in front perspective view an example 3D-printed building element having frame portions according to one embodiment of the present disclosure.

FIG. 7B illustrates in top perspective view an example 3D-printed building element having curved regions according to one embodiment of the present disclosure.

FIG. 8 illustrates a flowchart of an example detailed method of producing 3D-printed building elements according to one embodiment of the present disclosure.

FIG. 9A illustrates in block diagram format an example expandable system for manufacturing 3D-printed building elements according to one embodiment of the present disclosure.

FIG. 9B illustrates in block diagram format an example expanded version of the system of FIG. 9A according to one embodiment of the present disclosure.

FIG. 10A illustrates in block diagram format an example alternative expandable system for manufacturing 3D-printed building elements according to one embodiment of the present disclosure.

FIG. 10B illustrates in block diagram format the system of FIG. 10A after a first expansion according to one embodiment of the present disclosure.

FIG. 10C illustrates in block diagram format the system of FIG. 10A after first and second expansions according to one embodiment of the present disclosure.

FIG. 10D illustrates in block diagram format the system of FIG. 10A after first, second, and third expansions according to one embodiment of the present disclosure.

FIG. 11 illustrates a flowchart of an example method of simulating a production line for manufacturing 3D-printed building elements according to one embodiment of the present disclosure.

FIG. 12 illustrates a graphical user interface for a software simulation tool configured to accept inputs for identifying an optimal configuration of a production line according to one embodiment of the present disclosure.

FIG. 13 illustrates a graphical user interface for a software simulation tool configured to accept user inputs regarding simulation of production line scenarios according to one embodiment of the present disclosure.

FIG. 14 illustrates a simulation model for a software simulation tool configured for identifying an optimal configuration of a production line according to one embodiment of the present disclosure.

FIG. 15 illustrates a graphical user interface for a software simulation tool configured to provide output regarding simulation of production line scenarios according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, techniques, and methods for manufacturing 3D printing based building elements. The disclosed embodiments can include systems and methods for manufacturing 3D-printed building elements in a variety of ways that allow for the production of a wide range of simple to complex types of building elements, high levels of flexibility in manufacturing such building elements and in configuring overall systems or production lines for such building element production, and improved system and production line footprint efficiency resulting in reduced amounts of overall space needed for building element production.

While traditional prefab construction companies can require large amounts of specialized equipment and large facilities with over 100,000 square feet per production line, the systems disclosed herein can include “micro-factory” production lines having footprints of less than about 12,000 square feet. Each such micro-factory production line can be designed to perform all required operations to produce prefab building elements such as 3D-printed panels having connectors and fully finished exterior surfaces. These systems and micro-factory production lines can include various production stations, such as printing stations having robotic and/or gantry based 3D-printing machines and a variety of post processing production stations having various industrial robotic subsystems. These systems and micro-factory production lines can work directly with CAD/CAE design systems to perform necessary tasks to produce various building elements. This can allow for a single set of equipment for different manufacturing operations as well as for manufacturing different variations of building elements with various requirements.

The various embodiments disclosed herein can include the use of manufacturing technologies that are performed by industrial robotic systems and/or gantry-based systems that are controlled electronically. Full production cycles can be performed automatically and can be controlled by a few skilled operators rather than the many laborers required for traditional prefab construction. Some or all of the industrial robotic systems and automated machines in the disclosed systems and methods can be controlled by software that reads various manufacturing parameters and inputs and then appropriately manages workflows and related operations and tasks. Computer vision systems integrated with the robotic systems can allow for fast and accurate quality control operations to be performed automatically.

In addition to the need for fewer workers, the use of versatile robotic systems that are able to perform multiple disparate operations, and the efficient design of smaller and more coordinated production stations, the disclosed systems and methods can also implement other features and techniques to reduce the overall footprints needed for prefab production lines and micro-factories. For example, the disclosed systems and methods can transport and perform some or all operations on building elements while the building elements are vertically oriented. This results in less space being needed throughout the production process within the system, since traditional prefab transport and operations like flipping panels or performing functions while panels are horizontally oriented are reduced or eliminated.

Although various embodiments disclosed herein discuss manufacturing items using designated production “stations” to conduct various manufacturing operations, it will be readily appreciated that the disclosed features, apparatuses, systems, and methods can also utilize rooms, cells, or even simply areas or regions to perform the various disclosed manufacturing operations. The disclosed systems and methods may also involve the use of production stations or areas that are common or shared for different or separate systems, such as in the case of packaging areas or waste areas that are shared by multiple separate systems. While the term “building element” is used throughout the present disclosure, it will be understood that this can also refer to a building component or other building item used to form a building at a construction site. Furthermore, while the various embodiments disclosed herein discuss 3D printing with respect to buildings and building elements and components, it will be readily appreciated that the disclosed systems and methods can similarly be used for any relevant type of 3D printing and any 3D-printed object. For example, the disclosed systems and methods can be used for the production of 3D printing based models, figures, and other items that are not for use in building construction. Other applications, arrangements, and extrapolations beyond the illustrated embodiments are also contemplated.

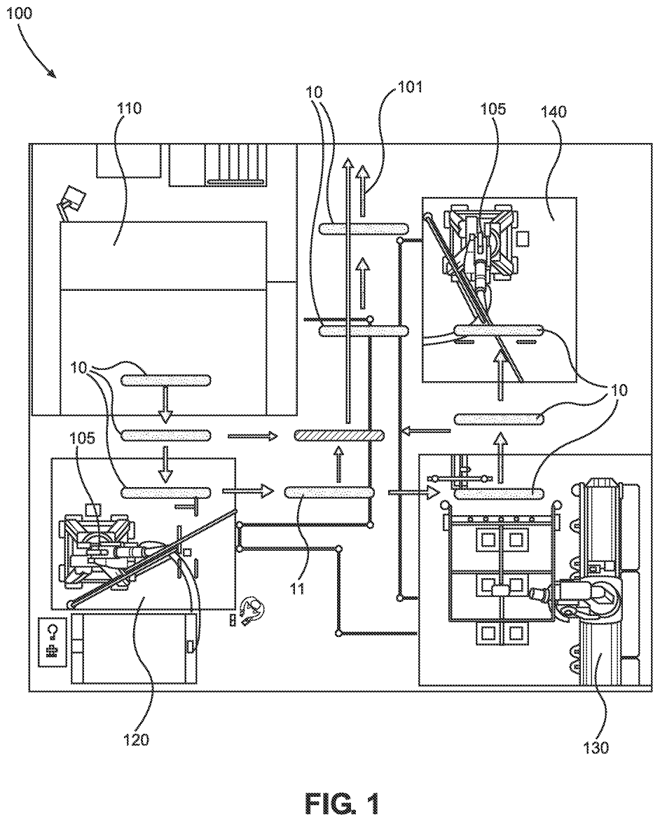

Referring first to FIG. 1, an example system 100 for manufacturing 3D-printed building elements is illustrated in top plan view. 3D-printed element manufacturing system 100 can be a basic system used to produce 3D-printed building elements 10, each of which can include at least a base portion formed by 3D printing a curable polymer material layer-by-layer. Various 3D-printed building elements 10 formed by system 100 can include, for example, building panels that can be used to form all or parts of walls, floors, ceilings, roofs, or various portions thereof, among other possible building parts, portions, or sections. 3D-printed element manufacturing system 100 can include multiple production stations, such as a printing station 110, an insulation station 120, a machining station 130, and a coating station 140. More than one of each type of production stations 110, 120, 130, 140 can be used in a given overall system 100, as may be desired. Other types of production stations are also possible, as detailed below.

Each printing station 110 can include a large-scale 3D-printing system having one or more automated machines or systems configured to automatically form 3D-printed building elements. This can include one or more customized gantry machines and proprietary printing heads that dispense a polymer photo-curable material to form the 3D-printed building elements. In some arrangements, the printing heads can also dispense continuous fibers, such as fiberglass fibers, for reinforcement of the polymer photo-curable material. This can result in the formation of 3D-printed fiber reinforced composite material panels, components, and elements that are large enough and strong enough to form building elements for building construction.

The printing head can move to create a desired 3D-printed building element geometry layer-by-layer, depositing material to form the base mass of the building element. Reinforcing fibers can be embedded within or otherwise incorporated with the 3D-printed material during printing. A curing subsystem may also be used within a printing station 110, and such a curing subsystem can be coupled to the printing head. Further details regarding 3D printing building elements, including fiber reinforced building elements, can be found in U.S. patent application Ser. No. 16/810,657, entitled “THREE-DIMENSIONAL PRINTING BUILDING COMPONENTS AND STRUCTURES,” and U.S. patent application Ser. No. 17/183,335, entitled “THREE-DIMENSIONAL PRINTING OF FREE-RADICAL POLYMERIZABLE COMPOSITES WITH CONTINUOUS FIBER REINFORCEMENT FOR BUILDING COMPONENTS AND BUILDINGS,” both of which are hereby incorporated by reference in their entireties herein.

Each insulation station 120 can include one or more automated machines or systems configured to automatically place one or more insulation materials into 3D-printed building elements 10. This can involve placing insulation material into one or more inner cavities formed within the 3D-printed building elements 10. Such inner cavities can be integrally formed within the 3D-printed building elements during the 3D printing process in printing station 110. In some arrangements, the insulation material can be a thermal insulation that can be polyurethane based. A high pressure dosing machine can be used to pour polyurethane material through hoses and a mixing head into the inner cavities, where polyurethane insulating foam can then be formed as a result of a chemical reaction. Any such insulation processes can occur while a 3D-printed building element 10 is arranged in a vertical orientation within an insulation station 120.

Each machining station 130 can include one or more automated machines or systems configured to automatically machine one or more surfaces of 3D-printed building elements 10. Such machining operations can include any type of cutting, drilling, angling, milling, beveling, surfacing, or other machining operations that may be used to form precise machine finished surfaces, edges, corners, and other regions in 3D-printed building elements 10. Such precise machining can form desired shapes as well as facilitate any possible future coupling of 3D-printed building elements to other building elements or building parts. For example, an industrial robot equipped with a milling head can be used to automatically mill a printed surface and also cut openings within a given 3D-printed building element 10 for any needed mechanical, electrical, and/or plumbing lines, as wells as to provide for future mechanical connections. Any such machining processes can occur while a 3D-printed building element 10 is arranged in a vertical orientation within a machining station 130.

Each coating station 140 can include one or more automated machines or systems configured to automatically apply one or more coating layers onto 3D-printed building elements 10. Coating layers can include, for example, primer, paint, varnish, lacquer, and/or any other suitable coating material, and can serve to protect the underlying building element from weather and other conditions such as moisture, ultraviolet radiation, dirt, pollution, and the like. Coating layers can also allow for color customization of all or portions of any given building element, such as by using colored paint. In some arrangements, a coating station 140 can also include one or more drying regions and/or separate drying machines or systems. Any such coating processes can occur while a 3D-printed building element 10 is arranged in a vertical orientation within a coating station 140.

In various arrangements, a production flow or line 101 can represent the general locations and movement or flow of one or more 3D-printed building elements 10 through system 100 along a single production line. Production flow or line 101 can also reflect the positioning of building elements within one or more of the production stations 110, 120, 130, 140. As one particular example, a given building element may originate in printing station 110 as it is printed, then move to insulation station 120 where it is insulated, then move to machining station 130 where it is machined, then move to coating station 140 where it is coated, after which the given building element can then exit system 100. In addition to the general location and movement of 3D-printed building elements 10, production flow 101 can also represent the general location and flow for scrapped items and materials 11 through system 100. As will be readily appreciated, each production station can result in scrapped or waste materials or items 11 during system production, and this scrap can be collected and moved through system 100 as well. In some arrangements, much of the collected waste or scrapped materials can be recycled, such as in the case of polymer photo-curable materials that can be converted to a material form that can then be printed into a new 3D-printed building element.

In some arrangements, one or more production stations can be skipped or its functions not used during the production of a given building element. For example, a very simple 3D-printed building element may originate in printing station 110 as it is printed, after which it can move directly to coating station 140 where it is coated, after which the very simple building element can then exit system 100. Other variations in production flow are also possible, and it is specifically contemplated that system 100 can be arranged such that any of stations 110, 120, 130, 140 can be configured to receive a particular 3D-printed building element 10 from any other of stations 110, 120, 130, 140 depending on circumstances. In particular, each of stations 110, 120, 130, 140 can be configured to receive 3D-printed building elements 10 in a vertical orientation from any other station 110, 120, 130, 140.

One or more lean manufacturing principles can be observed in the example configuration shown for system 100 in FIG. 1. This configuration of system 100 can result in, for example, a single-piece flow and a U-shape production line design, among other lean manufacturing principles. All functions and technologies of system 100 can result as balanced in cycle time, such that when one production station completes its operation or function on a given 3D-printed building element, the next production station can be available and the given 3D-printed building element can be moved to the next production station without buffering.

In various embodiments, one or more vehicles 105 can be used to move 3D-printed building elements 10 from one production station to another production station. In some arrangements, one or more of vehicles 105 can be manually driven and operated forklifts, for example. In some arrangements, at least one of vehicles 105 can be an automated guided vehicle (“AGV”) configured to automatically move 3D-printed building elements 10. Each AGV can be configured to automatically receive a 3D-printed building element 10 from one production station, move that building element to its next production station, and deliver that building element within the next production station in a manner such that the automated machines or systems in that next production station are able to perform operations on the building element.

In some cases, some or all of the receiving, moving, handling, and delivering of 3D-printed building elements 10 by any vehicle 105 can occur while the building elements are arranged in a vertical orientation. When coupled with the building elements being arranged in a vertical orientation during operation of the various production stations 110, 120, 130, 140, this can result in the 3D-printed building elements 10 being always arranged in a vertical orientation during all functions and processes within system 100. As will be readily appreciated, such an arrangement can significantly reduce the amount of space needed within a factory, production line, or other manufacturing system, such building elements that are vertically oriented can take up much less space than the same building elements when they are horizontally oriented.

In some arrangements, one or more AGVs or other vehicles 105 can be configured to be used as a printing base within a printing station 110. As such, an AGV or other vehicle 105 can be configured to move into printing station 110 and be positioned such that the one or more customized gantry machines and proprietary printing heads within the printing station operate to print a 3D-printed building element 10 onto a suitable printing region on or at the vehicle 105. The AGV or other vehicle 105 can then be able to move out of printing station 110 carrying the newly formed 3D-printed building element 10 in a vertical orientation and take the building element to its next production station, such as insulation station 120, for example.

In various situations, some or all building elements under production can be identified and tracked using one or more types of identifiers, such as barcodes, two-dimensional barcodes, and/or radio-frequency identification (“RFID”) tags. For example, each 3D-printed building element can have a unique RFID tag embedded within or attached to its material at a standard location during the printing process. This can be done manually or automatically by an automated component at printing station 110. These RFID tags can then be read at various locations throughout system 100, such as by vehicles 105 and at some or all of the different production stations 110, 120, 130, 140. The use of such digital technologies to identify and track 3D-printed building elements during production can allow for greater flexibility, viability, and security within system 100 with minimal additional costs.

In various embodiments, an operator can be located within or outside of the micro-factory or production line of system 100 shown in FIG. 1 such that the operator can observe, control, pause, and/or alter any or all processes within system 100 as needed. This can be done, for example, on an associated computer showing one or more live-stream videos, states of various machines, systems operations, alerts, and the like.

System 100 can also include one or more components or items outside of the micro-factory or production line shown in FIG. 1. One or more additional stations and/or spaces can be provided, for example, for various assembly, packaging, shipping, receiving, and other functions. In various arrangements, after the manufacturing processes shown in the production stations 110, 120, 130, 140 of FIG. 1 are finished, then the completed 3D-printed elements can be assembled with non-printed items and components as may be required by a particular design including, for example, steel frames, one or more mechanical/electrical/plumbing system items, and so forth. After these processes, 3D-printed elements can then be packaged and prepared for shipping.

Various combinations of some or all of the foregoing items and features can allow for micro-factory production of 3D-printed building elements in one or more production lines that are very space efficient and time efficient when producing a variety of different types of building elements. This can also allow for reduced labor, as a single operator can oversee a production line or even an entire facility, and fewer workers are required for packaging, shipping, warehousing, and other overall operation functions.

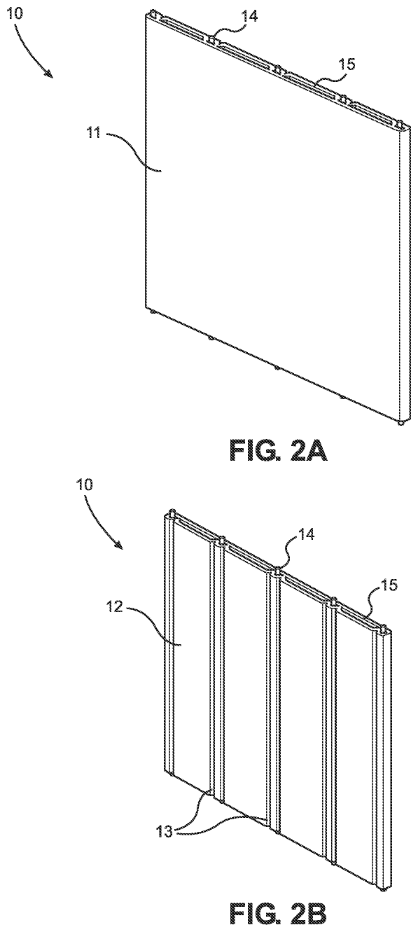

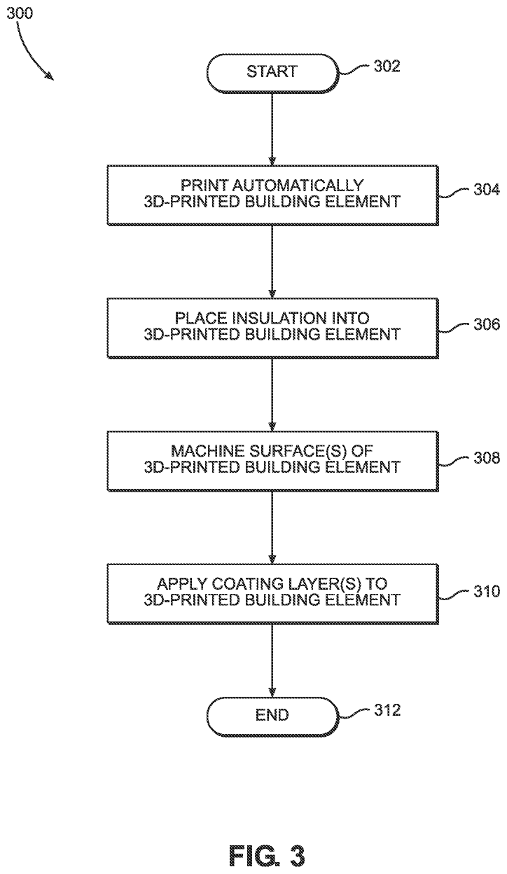

FIGS. 2A and 2B depict an example simple 3D-printed building element 10 in front perspective and obverse perspective views respectively. 3D-printed building element 10 can be used to provide all or part of a wall, floor, ceiling, roof, or other region for an overall building, and can be produced using system 100 as set forth above. 3D-printed building element 10 can have a smooth front side 11 and a segmented back side 12 having multiple grooved regions 13. Reinforcing fibers 14 can extend through 3D-printed building element 10 at various locations, and multiple inner cavities 15 can be formed in the building element, which inner cavities can be used to hold insulation in some arrangements. In some arrangements, 3D-printed building element 10 can be about 10 feet tall by about 10 feet wide by about ½ foot thick, although other smaller and larger dimensions are also possible. As shown in FIGS. 2A and 2B, 3D-printed building element 10 can be arranged in a vertical orientation such that the building element takes up less horizontal space than if it were arranged in a horizontal orientation.

Continuing with FIG. 3, a flowchart of an example summary method of producing a 3D-printed building element is provided. It will be readily appreciated that summary method 300 can be a high level method such that one or more steps can be omitted, various other steps can be added, and/or the order of steps can be altered as may be desired. After a start step 302, a first process step 304 can involve printing a 3D-printed building element. This can be done automatically and can take place in a designated printing station having an automated large-scale 3D-printing system configured to form at least a base portion of the 3D-printed building element.

At the next process step 306, insulation can be placed into the 3D-printed building element. This can be done automatically and can take place in a designated insulation station that can include one or more automated machines or systems configured to automatically place insulation into the 3D-printed building element.

At a following process step 308, one or more surfaces of the 3D-printed building element can be machined. This can be done automatically and can take place in a designated machining station that can include one or more automated machines or systems configured to automatically machine the one or more surfaces of the 3D-printed building element.

At subsequent process step 310, one or more coating layers can be applied to the 3D-printed building element. This can be done automatically and can take place in a designated coating station that can include one or more automated machines or systems configured to automatically coat the 3D-printed building element. The method can then end at end step 312.

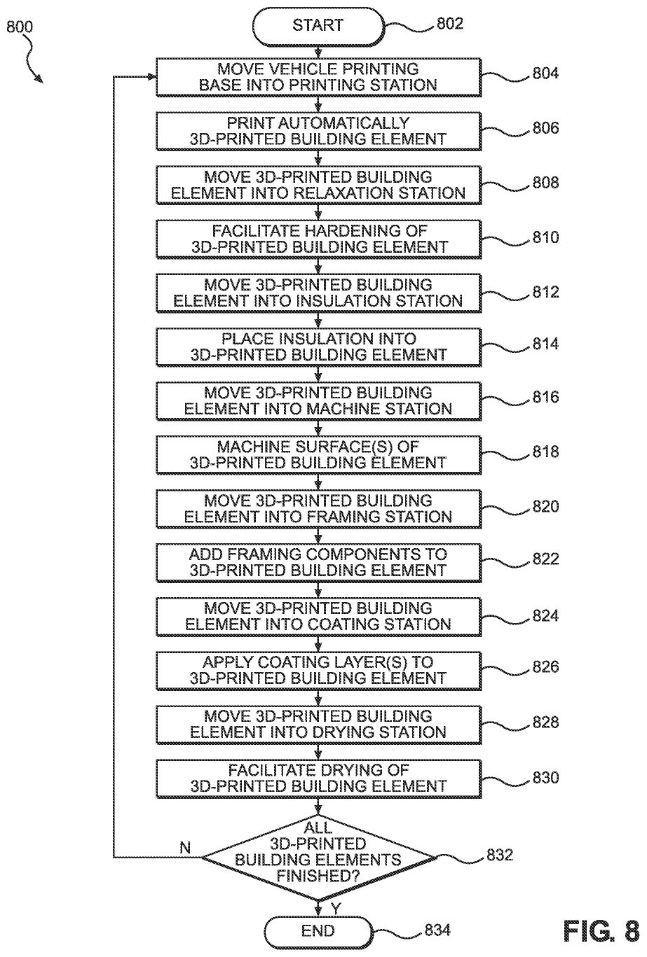

Some or all of steps 304 through 310 can be performed with the 3D-printed building element arranged in a vertical orientation. Again, method 300 can vary in some ways. For example, steps regarding moving the 3D-printed building element from one station to another can be included. This can include separate steps for moving the 3D-printed building element into each of the insulation station, the machining station, and the coating station, as well as a step for moving the 3D-printed building element out of the coating station. Furthermore, some steps can be performed in a different order and some steps can be performed simultaneously. For example, all of steps 304-310 can be performed simultaneously during continuous and ongoing production of multiple separate 3D-printed building elements. Further possible detailed steps and description are provided below with respect to the detailed method set forth in FIG. 8.

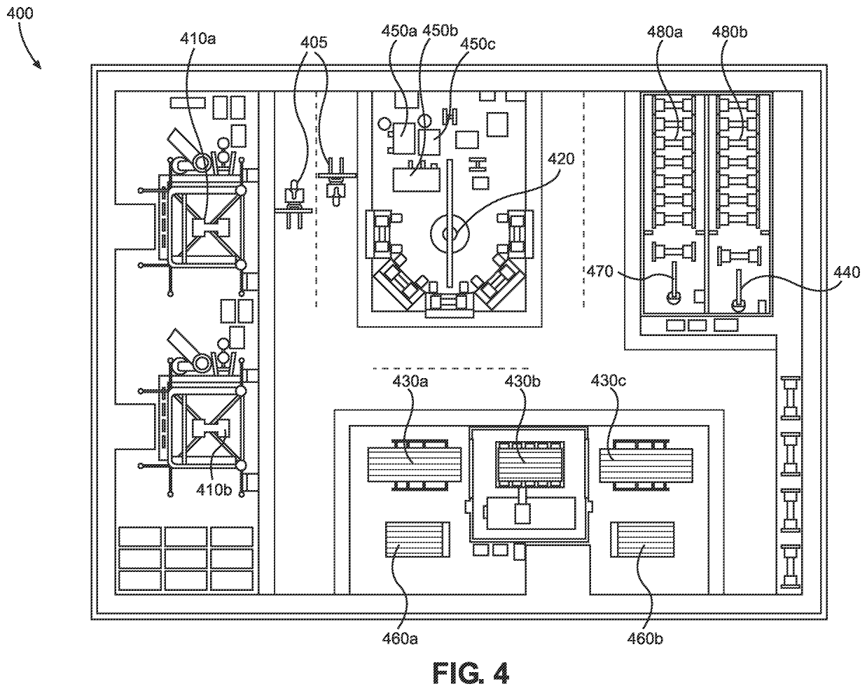

Moving next to FIG. 4, an example alternative system for manufacturing 3D-printed building elements is illustrated in block diagram format. 3D-printed element manufacturing system 400 can be similar to system 100 above, except that system 400 can be relatively more complex and can include additional production stations and other features and details not found in the relatively simpler system 100. Similar to the foregoing examples, 3D-printed element manufacturing system 400 can include multiple production stations such as printing stations 410a, 410b, insulation station 420, machining stations 430a, 430b, 430c, and coating station 440, as well as one or more automated and/or manually operated vehicles 405 configured to move 3D-printed elements within and about the system. As in the above example, system 400 can include one or more of each of these production station types 410, 420, 430, 440, and multiples of the same station type can be advantageous in allowing increased production for the functions at a given station type.

In addition to these production stations and features, system 400 can also include one or more relaxation stations 450a, 450b, 450c, one or more framing stations 460a, 460b, one or more priming stations 470, and one or more sets of drying stations 480a, 480b, among other possible production station types. Additional station types and functions not shown can include, for example, stations and other areas for receiving, assembly, packaging, shipping, warehousing, recycling, and scrap collection, among other possible stations and functions. Such additional production stations and areas can be included within the footprint shown for system 400 or can be at one or more other locations outside of this illustrated footprint in FIG. 4. As shown, the various production stations of system 400 can be generally arranged into a single production line that is more robust and complex than the production line of system 100.

Each relaxation station 450a, 450b, 450c can include one or more hardening or settling locations and/or automated machines or systems configured to automatically facilitate the hardening or settling of freshly printed 3D-printed building elements right after the 3D-printing process. Added time to harden or settle after printing can be particularly useful in the case of 3D-printed building elements having complex geometries or certain types of specialty printing materials. Each relaxation station 450a, 450b, 450c can be configured to facilitate the hardening or settling of freshly printed 3D-printed building elements while the building elements are arranged in a vertical orientation, and each relaxation station can be configured to receive the 3D-printed building elements arranged in a vertical orientation directly from a printing station or from any other production station as may be applicable. In many arrangements, use of a relaxation station can be particularly helpful immediately after a 3D-printed building element leaves a printing station and immediately before the building element enters an insulation station.

Each framing station 460a, 460b can include one or more automated machines or systems configured to automatically or semi-automatically assemble 3D-printed building elements with additional building components. Such additional building components can be formed from metal, wood, plastic, or other materials, and can include, for example, frame members, subpanels, extensions, steps, connectors, hinges, sensors, and the like. Each framing station 460a, 460b can be configured to facilitate framing operations for 3D-printed building elements while the building elements are arranged in a vertical orientation, and each framing station can be configured to receive the 3D-printed building elements arranged in a vertical orientation directly from a machining station or from any other production station as may be applicable. In many arrangements, use of a framing station can be particularly helpful immediately after a 3D-printed building element leaves a machining station and immediately before the building element enters a priming station or coating station.

Each priming station 470 can include one or more automated machines or systems configured to automatically apply one or more primer layers onto 3D-printed building elements, such that priming station 470 can be similar to coating station 440. In some arrangements, a coating station can also serve as a priming station. Application of a primer layer (i.e., “priming”) may take place before other intermediary functions are performed on a 3D-printed building element, such as machining or framing functions, and/or priming may also take place prior to a coating function at a coating station 440. Each priming station 470 can be configured to apply a primer layer to 3D-printed building elements while the building elements are arranged in a vertical orientation, and each priming station can be configured to receive the 3D-printed building elements arranged in a vertical orientation from an insulation station or from any other production station as may be applicable.

Each drying station 480a, 480b can include one or more drying locations and/or automated machines or systems configured to automatically facilitate the drying of freshly primed or coated 3D-printed building elements right after a priming or coating process. Each drying station 480a, 480b can be configured to facilitate the drying of freshly primed or coated 3D-printed building elements while the building elements are arranged in a vertical orientation, and each drying station can be configured to receive the 3D-printed building elements arranged in a vertical orientation directly from a priming station, a coating station or from any other production station as may be applicable.

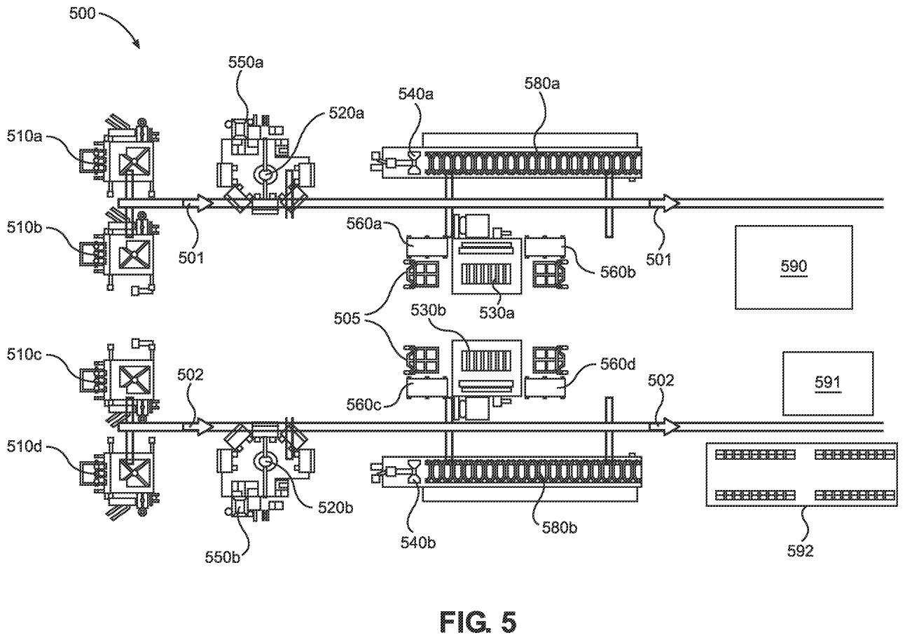

Continuing with FIG. 5, an example system for manufacturing 3D-printed building elements having multiple production lines is shown in block diagram format. 3D-printed element manufacturing system 500 can be similar to systems 100 and 400 set forth above, except that system 500 can include multiple separate production lines that can be operated independently from each other. In particular, system 500 can include a first production line 501 and a second production line 502. While production lines 501 and 502 are shown as being identical or substantially similar, it will be appreciated that other manufacturing systems having multiple production lines can have production lines that differ in a variety of ways.

Similar to the foregoing embodiments, each production line 501, 502 can have multiple different production stations. Production line 501 can have printing stations 510a, 510b, relaxation station 550a, insulation station 520a, machining station 530a, framing stations 560a, 560b, coating and priming station 540a, and drying station 580a, all of which can be arranged in this general order of production. Production line 502 can have printing stations 510c, 510d, relaxation station 550b, insulation station 520b, machining station 530b, framing stations 560c, 560d, coating and priming station 540b, and drying station 580b, all of which can be arranged in this general order of production. Each of these various production stations can be identical or substantially similar to production stations in the foregoing examples.

One or more vehicles 505 can be automated and/or manually operated and can serve to move 3D-printed building elements from one station to another. Such movement can be along the general flow of a production line 501, 502, or can be between stations out of order as may be desired. In some arrangements, vehicles 505 can be used to move building elements from a production station on production line 501 to a production station on production line 502, or vice-versa, such as where equipment in one production station is being serviced or where a given production station is backed up and a corresponding station on the other production line is not being used. System 500 can also include various stations or areas that can be common to both production lines 501, 502, such as a general assembly area 590, a shipping area 591, and a materials storage area 592, among other possible stations and areas.

In various embodiments, one or more improvements or useful adjustments can be provided in any of the foregoing systems 100, 400, 500, or any other similar 3D-printed element manufacturing system. For example, a given printing station can utilize a gantry kinematic system or a standard industrial robotic system for its automated system components. Depending on specific manufacturing requirements, variations can arise in the chosen gantry system and other robotic systems, brands of robotic and other equipment, and the particular materials used for production, such as printing materials, insulation materials, framing materials, primers, paints, other coatings, and the like.

Other improvements or useful adjustments can include the removal or addition of various drying stations or processes from a given production line depending on whether it is required for building elements being produced to dry between some production operations. In some arrangements, multiple production stations can be placed next to each other in mirrored or similar orientations in order to meet zoning or environmental requirements and/or to leverage the use of common types of automated equipment or machinery. For example, a single automated insulation machine may be positioned between multiple different insulation stations.

In various arrangements, a given production line or overall system can be controlled by a single control system where all production stations are connected to the single control system. In other arrangements, some or all of the production stations can be controlled by separate control systems, each of which are dedicated to a single production station. Such arrangements can also include individual control systems that are responsible for controlling multiple production stations while other individual control systems are dedicated to a single production station. Other arrangements are also possible.

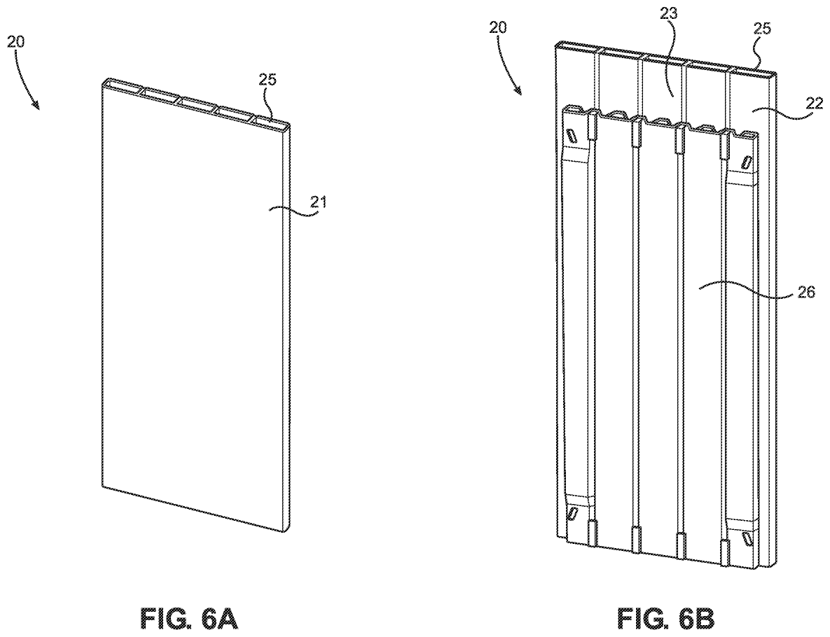

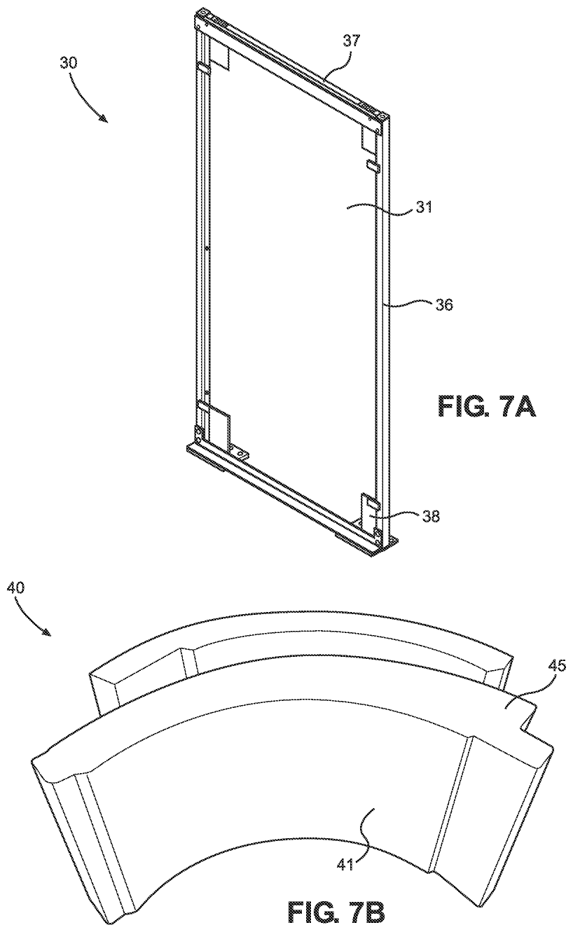

As will be readily appreciated, the more advanced and complex natures of systems 400 and 500 can allow for a greater variety of more complex 3D-printed building elements to be produced. Such 3D-printed building elements can include those with complex geometries, detailed features, and/or added building materials that can provide additional structural support and/or functionalities beyond those of simple 3D-printed building element 10 above. FIGS. 6A through 7B provide just a few examples of the more complex types of 3D-printed building elements that can be produced using these or other similar systems, and it will be readily appreciated that many other complex types of 3D-printed building elements can also be formed using the various systems and methods disclosed herein.

Starting with FIGS. 6A and 6B, an example complex 3D-printed building element is illustrated in front perspective and obverse perspective views respectively. As in the foregoing example, complex 3D-printed building element 20 can be used to provide all or part of a wall, floor, ceiling, roof, or other region for an overall building, and can be produced using system 400 or 500 as set forth above. 3D-printed building element 20 can have a base 3D-printed portion that includes a smooth front side 21, a segmented back side 22 having multiple grooved regions 23, and multiple inner cavities 25 that can be used to hold insulation in some arrangements, similar to simple 3D-printed building element 10 above, for example.

3D-printed building element 20 can also have a frame component 26 attached to its back side 22, such as by coupling to some or all of grooved regions 23, for example. One or more nails, screws, clips, or other items can be used to fasten frame component 26 to the main printed body of 3D-printed building element 20. This frame component 26 can be formed separately from one or more different materials, such as metal, wood, or plastic, and can provide additional structural strength and one or more detailed features that are difficult or impossible to provide in the 3D-printed material portions of building element 20. In some arrangements, 3D-printed building element 20 can be about 10 feet tall by about 5 feet wide by about ½ foot thick, although other smaller and larger dimensions are also possible. As shown in FIGS. 6A and 6B, 3D-printed building element 20 can be arranged in a vertical orientation such that it takes up less horizontal space than if it were arranged in a horizontal orientation.

FIG. 7A illustrates in front perspective view an example 3D-printed building element having frame portions. As in the foregoing examples, complex 3D-printed building element 30 can be used to provide all or part of a wall, floor, ceiling, roof, or other region for an overall building, and can be produced using system 400 or 500 as set forth above. 3D-printed building element 30 can have a base 3D-printed portion 31 similar to the 3D-printed portions of the above examples 10 and 20, as well as various attached frame elements that can be formed from other materials. These can include, for example, side frame arms 36, a top frame arm 37, and one or more brackets or hinged items 38, among other possible frame items. In some arrangements, 3D-printed building element 30 can be a further processed iteration of building element 20 above. As shown in FIG. 7A, complex 3D-printed building element 30 can also be arranged in a vertical orientation such that it takes up less horizontal space than if it were arranged in a horizontal orientation.

FIG. 7B illustrates in top perspective view an example 3D-printed building element having curved regions according to one embodiment of the present disclosure. 3D-printed building element 40 can have a base 3D-printed portion 41 similar to the 3D-printed portions of the above examples 10, 20, 30, although this printed portion can be formed into a substantially curved shape, as shown. Insulation material 45 can be installed into one or more cavities within this 3D-printed portion 41, and various edges, corners, and other portions of 3D-printed building element 40 can be machined to provide exact dimensions for future connections to other building elements or components as may be desired. As shown in FIG. 7B, complex 3D-printed building element 40 can also be arranged in a vertical orientation such that it takes up less horizontal space than if it were arranged in a horizontal orientation.

As will be readily appreciated, various combinations of different production stations may be used for the formation or manufacture of each of 3D-printed building elements 20, 30, and 40. For example, 3D-printed building element 20 might be formed by using a printing station, then an insulation station, then a machining station, then a framing station, then a coating station, and then a drying station, after which packaging and/or storage stations or areas can be used. 3D-printed building element 30 might be formed by using a printing station, then a relaxation station, then an insulation station, then a priming station, then a drying station, then a machining station, then a framing station, then a coating station, and then a drying station, after which packaging and/or storage stations or areas can be used. Because no framing operations are needed, 3D-printed building element 40 might be formed by using a printing station, then a relaxation station, then an insulation station, then a machining station, then a coating station, and then a drying station, after which packaging and/or storage stations or areas can be used. Other types of production stations and orders of production functions may also be used, and it will be understood that these types of production stations and orders of production can vary depending upon the needs of a given 3D-printed building element.

Turning next to FIG. 8, a flowchart of an example detailed method 800 of producing 3D-printed building elements is provided. Method 800 can be a detailed version of method 300 set forth above, with various steps and details being interchangeable and/or removable from one or both methods. As in the above method 300, various steps of method 800 can be performed in different orders and/or simultaneously, such as during a continuous process of producing multiple 3D-printed building elements. Furthermore, some or all steps may be repeated as desired in varying orders until all desired 3D-printed building elements are produced.

After a start step 802, a first process step 804 can involve moving a vehicle having a printing base into a printing station. As noted above, one or more manually operated forklifts, AGVs, and/or other vehicles can have a printing base configured to support the direct printing thereupon of a base component for a 3D-printed building element. Such a printing base can be positioned with respect to a gantry and/or other automated printing components to facilitate the printing of the base component.

At a subsequent process step 806, a base portion or component for a 3D-printed building component can be printed within the printing station. This can be done automatically by an automated large-scale 3D-printing system, which can include an automated gantry and/or other automated printing components, such as a movable printing head, a curing system, and other items. Printing can result in the formation of the base component, which can be arranged in a vertical orientation on a printing base that can be on a vehicle, for example.

Process step 808 can then involve moving the 3D-printed building element into a relaxation station. This can include moving the 3D-printed building element out of a prior station, such as a printing station, for example. Such movement can be accomplished using a manually operated or automated vehicle and can occur while the 3D-printed building element is arranged in a vertical orientation on the vehicle.

At the next process step 810, hardening of the 3D-printed building element can be facilitated. This can be done automatically and can take place in a designated relaxation station that can include one or more automated machines or systems configured to automatically facilitate the hardening and/or settling of the freshly printed 3D-printed building element. Such hardening and/or settling operations can occur while the 3D-printed building element is arranged in a vertical orientation in the relaxation station.

Process step 812 can then involve moving the 3D-printed building element into an insulation station. This can include moving the 3D-printed building element out of a prior station, such as a relaxation station, for example. Such movement can be accomplished using a manually operated or automated vehicle and can occur while the 3D-printed building element is arranged in a vertical orientation on the vehicle.

At a following process step 814, insulation can be placed into the 3D-printed building element. This can be done automatically and can take place in a designated insulation station that can include one or more automated machines or systems configured to automatically place insulation into the 3D-printed building element. Also, insulating operations can occur while the 3D-printed building element is arranged in a vertical orientation in the insulating station.

Process step 816 can then involve moving the 3D-printed building element into a machining station. This can include moving the 3D-printed building element out of a prior station, such as an insulation station, for example. Such movement can be accomplished using a manually operated or automated vehicle and can occur arranged while the 3D-printed building element is arranged in a vertical orientation on the vehicle.

At subsequent process step 818, one or more surfaces of the 3D-printed building element can be machined. This can be done automatically and can take place in a designated machining station that can include one or more automated machines or systems configured to automatically machine the one or more surfaces of the 3D-printed building element. Also, machining operations can occur while the 3D-printed building element is arranged in a vertical orientation in the machining station.

Process step 820 can then involve moving the 3D-printed building element into a framing station. This can include moving the 3D-printed building element out of a prior station, such as a machining station, for example. Such movement can be accomplished using a manually operated or automated vehicle and can occur arranged while the 3D-printed building element is arranged in a vertical orientation on the vehicle.

At the next process step 822, one or more framing components can be assembled or otherwise added to the 3D-printed building element. This can be done automatically and can take place in a designated framing station that can include one or more automated machines or systems configured to automatically assemble or add the additional framing components to the 3D-printed building element. Such framing operations can occur while the 3D-printed building element is arranged in a vertical orientation in the framing station.

Process step 824 can then involve moving the 3D-printed building element into a coating (or priming) station. This can include moving the 3D-printed building element out of a prior station, such as a framing station, for example. Such movement can be accomplished using a manually operated or automated vehicle and can occur while the 3D-printed building element is arranged in a vertical orientation on the vehicle.

At a following process step 826, one or more coating layers can be applied to the 3D-printed building element. This can be done automatically and can take place in a designated coating station that can include one or more automated machines or systems configured to automatically coat the 3D-printed building element. Coatings can include primer, paint, varnish, lacquer, or any other desired coating material. Also, coating operations can occur while the 3D-printed building element is arranged in a vertical orientation in the coating station.

Process step 828 can then involve moving the 3D-printed building element into a drying station. This can include moving the 3D-printed building element out of a prior station, such as a coating or priming station, for example. Such movement can be accomplished using a manually operated or automated vehicle and can occur while the 3D-printed building element is arranged in a vertical orientation on the vehicle.

At the next process step 830, drying of the 3D-printed building element can be facilitated. In particular, one or more coating layers on the building element can be dried. This can take place in a drying station configured to automatically facilitate drying of one or more coating layers applied by a coating station. In some arrangements, coating and drying functions can be alternated between coating and drying stations for each layer to be applied to the 3D-printed building element. Such drying operations can occur while the 3D-printed building element is arranged in a vertical orientation in the drying station.

At subsequent decision step 832, an inquiry can be made as to whether production is finished for all desired 3D-printed building elements. If not, then the method can revert to process step 804 (or step 806 in some arrangements) and some or all steps can be repeated for additional building elements. If all desired building elements are finished at decision step 832, however, then the method can end at end step 834.

Again, all steps can be performed simultaneously and in automated fashion, such that multiple separate 3D-printed building elements of the same or different types can be produced at the same time. In addition, not all steps will be needed for some 3D-printed building elements, such that movement to and functions within a given production station can be skipped where a particular building element does not require such function or functions. Furthermore, the order of steps can be altered as may be practical or optimal for a given building element. Additional steps or functions can also be performed as may be necessary. Such additional steps can include the use of a general assembly area and associated functions, a packaging area and associated functions, a shipping area and associated functions, and a materials storage area and associated functions, recycling materials and scrapping materials, among other possible process steps.

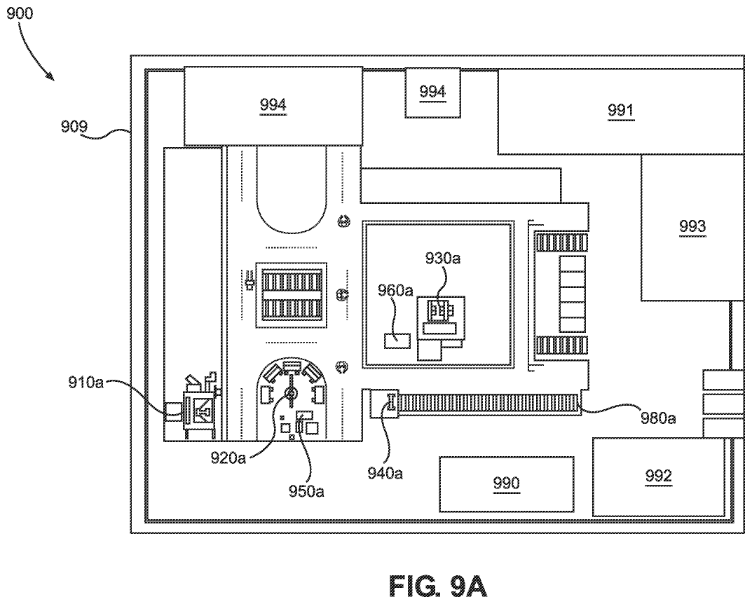

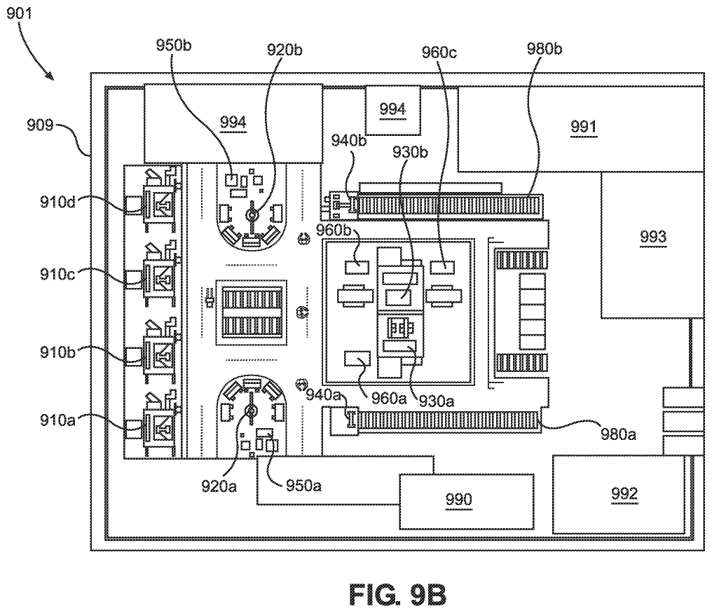

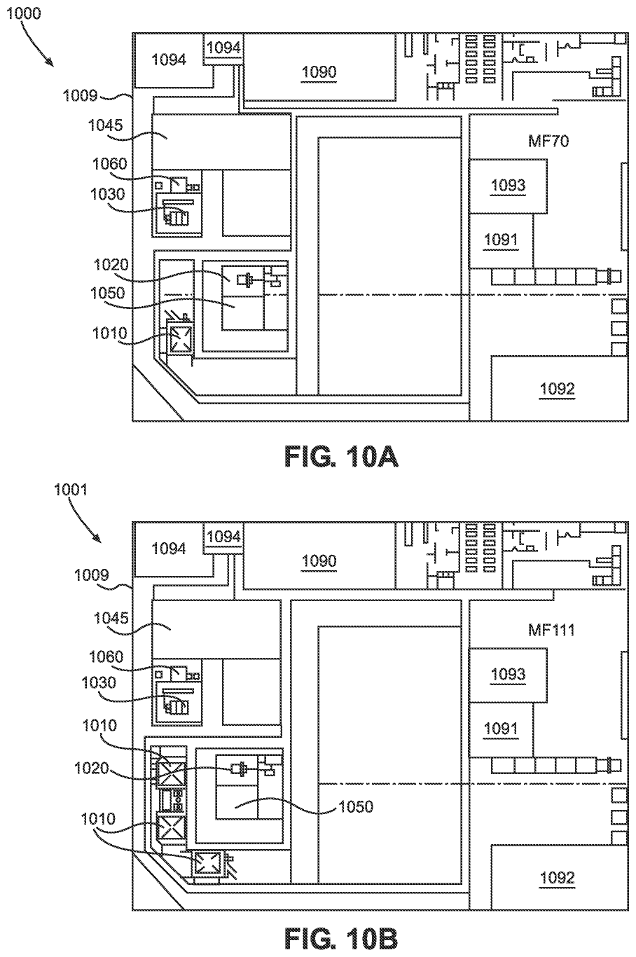

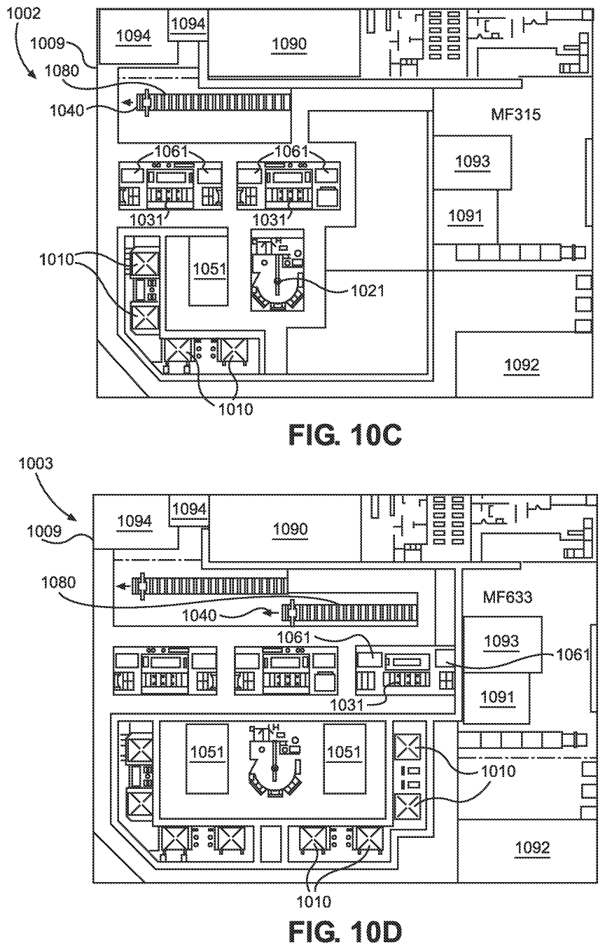

Transitioning next to FIGS. 9A through 10D, various examples for configuring and expanding production lines and/or overall manufacturing systems for the production of 3D-printed building elements will now be provided. As an initial example, FIG. 9A illustrates in block diagram format an example expandable system for manufacturing 3D-printed building elements, while FIG. 9B illustrates in block diagram format an example expanded version of the system of FIG. 9A. As will be readily appreciated from these examples, implementation of an expandable system or micro-factory arrangement can allow for a great amount of flexibility not only for the immediate production of 3D-printed building elements that are currently in demand, but also for the future production of increased numbers of the currently required 3D-printed building elements as well as other types of building elements that may be in demand later.

Initial expandable system 900 can include an outer perimeter 909 that can define the physical boundary or limit of a factory or other facility within which the system is located. Various regions within outer perimeter 909 can be flexibly modified or expanded, while other regions within this outer perimeter can be fixed. Such fixed regions can include, for example, a general assembly area 990, a shipping area 991, a materials storage area 992, a packaging area 993, and various utility areas 994 that can be used for electrical, water, pressurized gases, and other assorted utilities, among other possible fixed areas and features.

Initial expandable system 900 can have an initial configuration of production stations that can be configured to produce a minimal level of 3D-printed building components. These can include, for example, a single printing station 910a, a single relaxation station 950a, a single insulation station 920a, a single machining station 930a, a single framing station 960a, a single coating station 940a, and a single drying station 980a. This minimal configuration can be arranged into a single production line such that modifications and/or expansions can be readily accomplished as future demands or needs may arise.

Expanded system 901 can represent a later expansion of this initial expandable system 900 due to increased future demands or needs. As such, expanded system 901, which can be contained within the same outer perimeter 909 of the relevant factory or facility, can include multiple production stations for each production station type, which can be in addition to the initial production stations listed above for initial expandable system 900. These additional production stations can include printing stations 910b, 910c, 910d, relaxation station 950b, insulation station 920b, machining station 930b, framing stations 960b, 960c, coating station 940b, and drying station 980b. Of course, this is just one expansion example, and other expansions of multiple types of production stations are also possible. In various arrangements, the expansion of initial expandable system 900 into expanded system 901 within the same overall factory or facility can result in multiple separate production lines as well as a production throughput that is more than doubled. Such expansion (or modification) can also allow for a greater variety of different 3D-printed building component types in some situations.

Various advantages can be realized through the implementation of micro-factories and systems having configurations that can be modified or expanded as needs or demands change. In general, the much smaller footprints of any such system can advantageously be less than about 15,000 or even 10,000 square feet, which may or may not include provisions for standard warehouse and factory infrastructure, such as electrical transformer rooms, compressed air rooms, plumbing arrangements, and other normal utilities. Such significantly reduced factory and system footprints can then allow for the acquisition of real estate and cheaper and/or more convenient locations, such as closer to building sites and/or relevant labor pools. Some basic requirements for a system facility using the disclosed systems and methods can be reflected in Table 1 below, and it will be understood that other system facility requirements are also possible.

TABLE 1
BASIC PRODUCTION FACILITY REQUIREMENTS

| | | |
|---|---|---|
| Electrical power | 2000 | kVA |
| Compressed air | 100 | psi |
| Internet connection | 500/500 | Mbit |
| Minimum ceiling height | 7 | m |
| Reinforced polished concrete floor thickness | >150 | mm |
| Minimum space required | 15,000 | sq ft. |

| | |
|---|---|
| Temperature range | 0° C. to 40° C. |
| Land and building zoning | Medium-Heavy Industrial |
| Minimum operation crew size | 10 |

Since a given system or facility using the disclosed systems and methods can have several micro-factory production lines, such a facility can be very flexible in that it may have multiple production lines working in parallel, rather than a single production line. Modification of existing production lines and/or expansion to include additional production lines within a given factory or facility can also be much more viable using the disclosed systems and methods, since a greater level of capital efficiency can be realized. Rather than deploying an entire factory or facility with high capital expenditures at an initial deployment or development stage, the disclosed micro-factory approach can allow for the deploying of an initial single micro-factory line, start production with that single production line, and then add one or more production lines when needed to meet future market demands.

Furthermore, the disclosed embodiments can result in faster deployment cycles, since these systems and methods do not require traditionally complex equipment and significantly increased multi-step zoning, development, and deployment processes. Rather, the disclosed micro-factory approach can result in new production lines that can be implemented within 1-3 months compared to the typical 6-12 months that are often required for traditional large factory designs. In addition to the foregoing, another advantage of the disclosed systems and methods can be reduced or even zero waste in construction. Through the use of additive manufacturing (i.e., 3D-printing) processes and techniques, minimal amounts of waste are generated due to the ability to recycles 3D-printing materials that are cut or otherwise removed from panels and other 3D-printed building elements during the production processes disclosed herein.

As another non-limiting example, FIGS. 10A through 10D provide in progressing block diagram formats another possible arrangement for configuring and expanding production lines and/or overall manufacturing systems for the production of 3D-printed building elements. FIG. 10A illustrates in block diagram format an example initial expandable system for manufacturing 3D-printed building elements, while FIG. 10B shows the system of FIG. 10A after a first expansion, FIG. 10C depicts the system of FIG. 10A after first and second expansions, and FIG. 10D illustrates the system of FIG. 10A after first, second, and third expansions. Similar to the foregoing example, each overall system iteration can include an outer perimeter 1009 that can define the physical boundary or limit of a factory or other facility within which the system is located. Again, various regions within outer perimeter 1009 can be flexibly modified or expanded, while other regions within this outer perimeter can be fixed. Such fixed regions can include, for example, a general assembly area 1090, a shipping area 1091, a warehouse or materials storage area 1092, a packaging area 1093, and various utility areas 1094, among other possible fixed areas and features.

Initial expandable system 1000 can include a single type of each production station, which can include, for example, a single printing station 1010, a single relaxation station 1050, a single insulation station 1020, a single machining station 1030, a single framing station 1060, and a general coating and drying area 1045. Once expanded system 1001 can include the same items as system 1000, except that two additional printing stations 1010 have been added.

Twice expanded system 1002 can include an additional (fourth) printing station 1010, an expanded relaxation station 1051, a new larger insulation station 1021, new larger machining stations 1031, new larger framing stations 1061, and a new coating station 1040 and a new drying station 1080 in place of the previous general coating and drying area 1045. Finally, thrice expanded system 1003 can include four more printing stations 1010 for a total of eight printing stations, another expanded relaxation station 1051, an additional machining station 1031 and further framing stations 1061, another coating station 1040, and another drying station 1080. Each expansion or increased iteration of the overall system from initial expandable system 1000 to thrice expanded system 1003 can result in expanded or additional production lines, as wells as increased manufacturing frequency or capacity of the system.

The provided “MF” numbers on each system iteration 1000, 1001, 1002, 1003 can represent the manufacturing frequency or capacity of a given system or micro-factory. In the case of “MF70,” for example, this can indicate that initial expandable system 1000 is able to produce just 70 panels or 3D-printed building elements per year. In the case of “MF111,” for example, this can indicate that expanded system 1001 is able to produce 111 panels or 3D-printed building elements per year. In the case of “MF315,” for example, this can indicate that twice expanded system 1002 is able to produce 315 panels or 3D-printed building elements per year. In the case of “MF633,” for example, this can indicate that thrice expanded system 1003 is able to produce 633 panels or 3D-printed building elements per year. Other production or throughput levels are also possible, as well as other timeframes for these and other metrics.

Transitioning next to design implications regarding configuring the types of systems, factories, micro-factories, and production lines disclosed herein, various types of computer-aided design (“CAD”) and computer-aided engineering (“CAE”) can be used to facilitate determining such configurations. In various embodiments, a software simulation tool can be used to analyze data and identify an optimal configuration for an overall manufacturing system, the layout for a factory or micro-factory, and/or the layout for one or more production lines. This software simulation tool can be operable to utilize and/or generate various types of data and/or other types of information when performing specific tasks and/or operations. This may include, for example, data or information input, data analysis, and/or data or information output. In at least one embodiment, the software simulation tool may be operable to access, process, and/or otherwise utilize information from one or more different types of sources, such as, for example, one or more user inputs and one or more local and/or remote memories, devices and/or systems. Additionally, the software simulation tool may be operable to generate one or more different types of output data/information, which, for example, may be stored in memory of one or more local and/or remote devices, systems, and/or databases.

The various techniques for implementing a software simulation tool or other similar system described herein may be implemented in software, hardware and/or hardware+software. The software simulation tool can be implemented as a resident or portable application that may reside, for example, in an operating system kernel, in a separate user process, in a library package bound into network applications, on a specially constructed machine, and/or on a network interface card, among other possible locations. In a specific embodiment, various aspects described herein may be implemented in software such as an operating system or in an application running on an operating system. Software, hardware and/or software+hardware hybrid embodiments of the software simulation tool described herein may be implemented on a general-purpose programmable machine selectively activated or reconfigured by a computer program stored in memory. Such a machine may include, for example, mobile or handheld computing systems, PDAs, smartphones, notebook computers, tablets, netbooks, desktop computing systems, server systems, cloud computing systems, network devices, and the like.

An example computer device or system can include one or more processors (e.g., a central processing unit, a graphics processing unit, or both), one or more main memories, and one or more static memories, which can communicate with each other via a bus. The computer device or system may further include a video display unit (e.g., a liquid crystal display or a cathode ray tube), and also an alphanumeric input device (e.g., a keyboard), a user interface, a navigation device (e.g., a mouse), a disk drive unit, a signal generation device (e.g., a speaker) and a network interface device, among other components. The disk drive unit can include a machine-readable medium on which is stored one or more sets of instructions and data structures (e.g., software) embodying or utilized by any one or more of the relevant methodologies or functions. The software may also reside, completely or at least partially, within a main memory and/or within any suitable processor during execution thereof by the computer device or system, wherein the main memory and/or the processor may also include machine-readable media.

The software simulation tool and various inputs and outputs therefor may further be transmitted or received over a network utilizing any one of a number of well-known transfer protocols (e.g., HTTP). While a relevant machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the relevant methodologies, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

According to various embodiments, a relevant computing device or system may include a variety of components, modules and/or systems for providing various types of functionalities. For example, the computing device or system may include a web browser application which is operable to process, execute, and/or support the use of scripts (e.g., JavaScript, AJAX, etc.), plug-ins, executable code, virtual machines, HTML5 vector-based web animation (e.g., Adobe Flash), etc. In at least one embodiment, the web browser application may be configured or designed to instantiate components and/or objects at the device or system in response to processing scripts, instructions, and/or other information received from a remote server such as a web server. Examples of such components and/or objects may include, but are not limited to, UI components, database components, processing components, and other components that may facilitate and/or enable the computing device or system to perform and/or initiate various types of operations, activities, functions such as those described herein with respect to providing a software simulation tool.

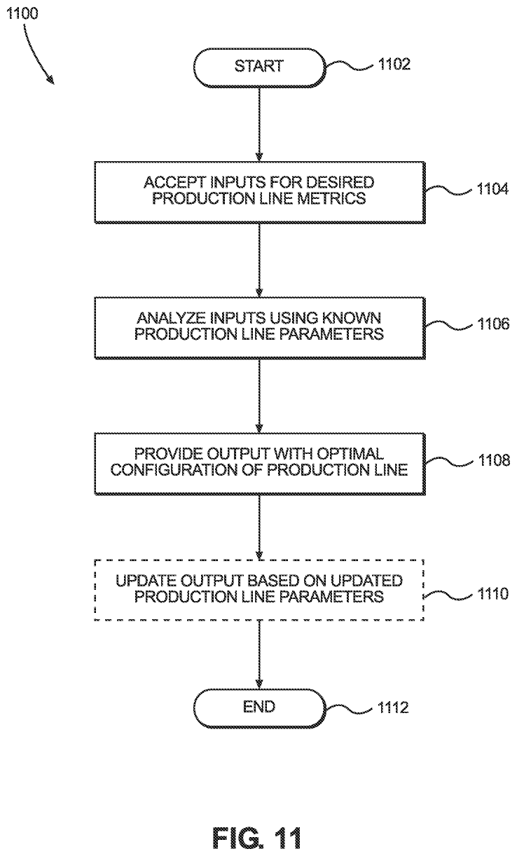

Again, the software simulation tool can be used to analyze data and identify an optimal configuration for an overall manufacturing system, the layout for a factory or micro-factory, and/or the layout for one or more production lines. FIG. 11 illustrates a flowchart of an example method 1100 of simulating a production line for manufacturing 3D-printed building elements. In various embodiments, method 1100 can be performed automatically by a computing device or system, such that the steps or functions set forth in this method can be implemented in computer code on one or more non-transitory computer readable media.

After a start step 1102, a first process step 1104 can involve accepting one or more inputs regarding desired production line metrics for manufacturing 3D-printed building elements. Such inputs can be user inputs, stored inputs, or a combination thereof. These inputs can include, but are not limited to, for example, desired amounts of scrap percentage per production station, rework percentage per produced 3D-printed building element, required time per produced 3D-printed building element, and maintenance downtime per production station. Other inputs can include known dimensions for a given or proposed manufacturing facility or production line, desired throughput for the manufacturing system, and the desired types of 3D-printed building elements to be produced at the system, among other possible inputs.

At the next process step 1106, the accepted inputs can be analyzed using known production line parameters. Such production line parameters can be provided by way of manual user inputs, parameters that are stored locally or remotely on one or more systems or databases, or a combination thereof. These production line parameters can include, but are not limited to, for example, system and operator requirements for various different types of 3D-printed building elements, dimensions, costs, materials, machinery, and expected throughputs for the various different production station and production area types, variable sizes and arrangements for different forms of the same type of production stations, vehicle types, sizes and costs, and operator requirements for selected production stations, vehicles, and other functions, among other possible parameters.

At subsequent process step 1108, one or more outputs can be provided that can include an optimal configuration for a production line. The one or more outputs can also include potential maximum throughput of 3D-printed building elements manufactured by the production line. The optimal configuration of the production line can include various definitions and items, such as, for example, at least a required number of printing stations, a required number of insulation stations, a required number of machining stations, and a required number of coating stations, among other possible production stations, as noted above. The optimal configuration of the production line can further include a required number of 3D-printed building element moving vehicles, a required number of 3D-printed building element stackers, a required number of quality engineers, a required number of general workers, a required number of worker shifts per day, a required amount of power consumption, an estimated amount of generated recycling, and an estimated amount of generated scrap. In various arrangements, the optimal configuration of the production line can further include an estimated carbon footprint per produced 3D-printed building element, and the overall one or more outputs can include information regarding costs to run the production line at different production capacities, as well as production schedules, among other possible outputs.

At an optional following step 1110, the one or more outputs can be updated based on one or more updated production line parameters and/or one or more inputs. This can involve taking a known configuration and expanding it based on updated needs or desires as these may change over time. Additional parameters and/or inputs can be provided to the system in addition to an existing system or production line configuration, and the system can then update the output based on these new additions. In some arrangements, this can resemble repeating steps 1104 through 1108 based on an existing system or production line configuration as a starting point for the analysis. In various arrangements, an updated set of production line parameters can include, for example, new equipment installed to the previous optimal configuration, fewer worker shifts than in the previous optimal configuration, different amounts of downtime per station than in the previous optimal configuration, one or more material shortages, or one or more economical metrics, among other possible parameters. The method can then end at end step 1112.

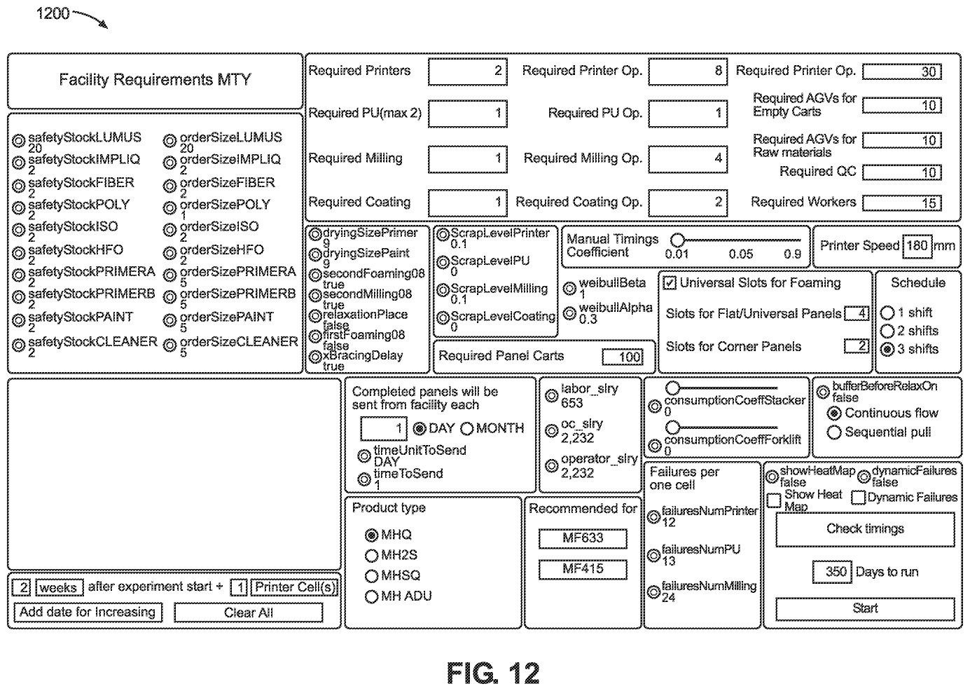

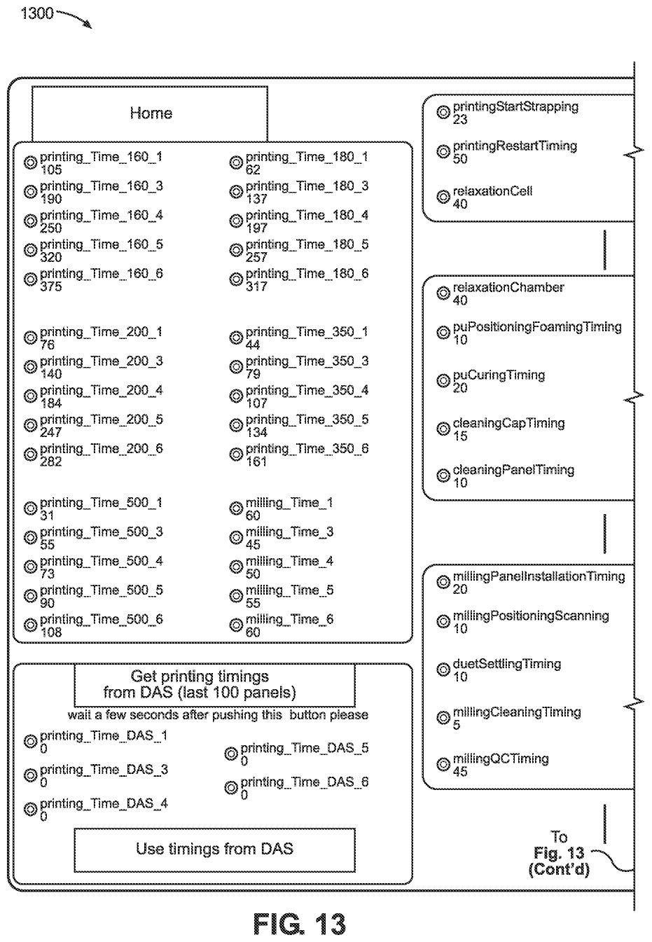

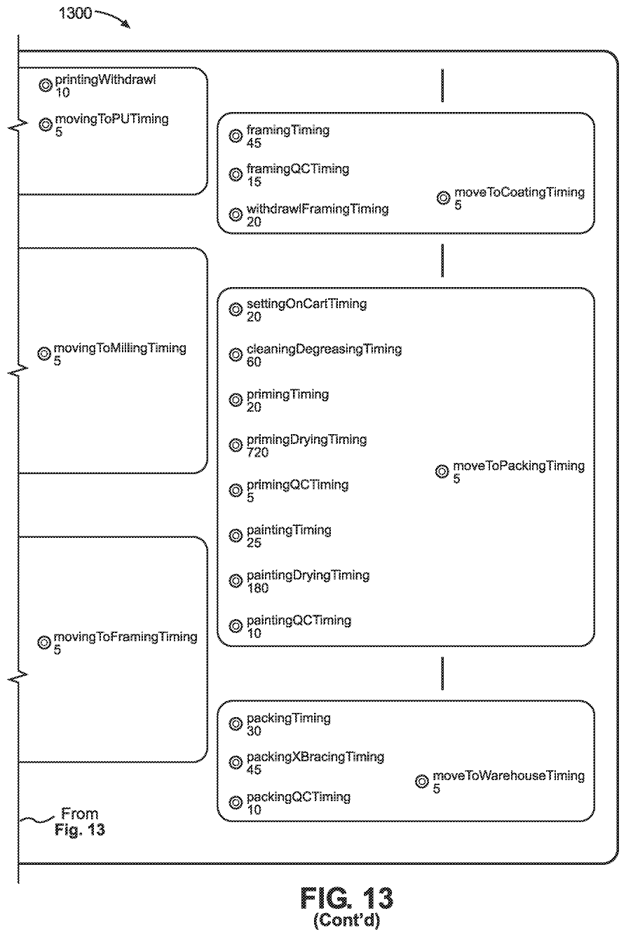

Various example graphical user interface (“GUI”) representations, outputs, and models of the software simulation tool will now be provided. FIG. 12 illustrates a GUI for a software simulation tool configured to accept inputs for identifying an optimal configuration of a production line. GUI screen 1200 can depict various data items and fields where inputs can be provided by a user manually or by an automated process, which can be facilitated by a user. FIG. 13 illustrates a GUI for a software simulation tool configured to accept user inputs regarding simulation of production line scenarios. GUI screen 1300 can depict various inputs that can be used for analysis by the software simulation tool. Such analysis can include running one or live simulations of different production scenarios under different facility or production line configurations. Such user inputs can include, for example, types and amounts of production stations, relative production station arrangements, and simulated or expected production results, which can include building elements made, throughput, scrap, recycling, and rework percentages, personnel requirements, station and system downtimes, and maintenance requirements, among other possible inputs.

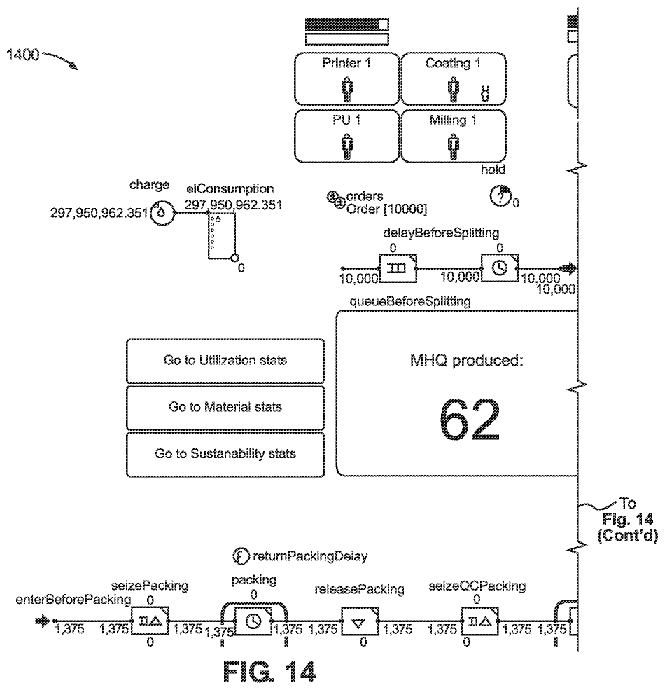

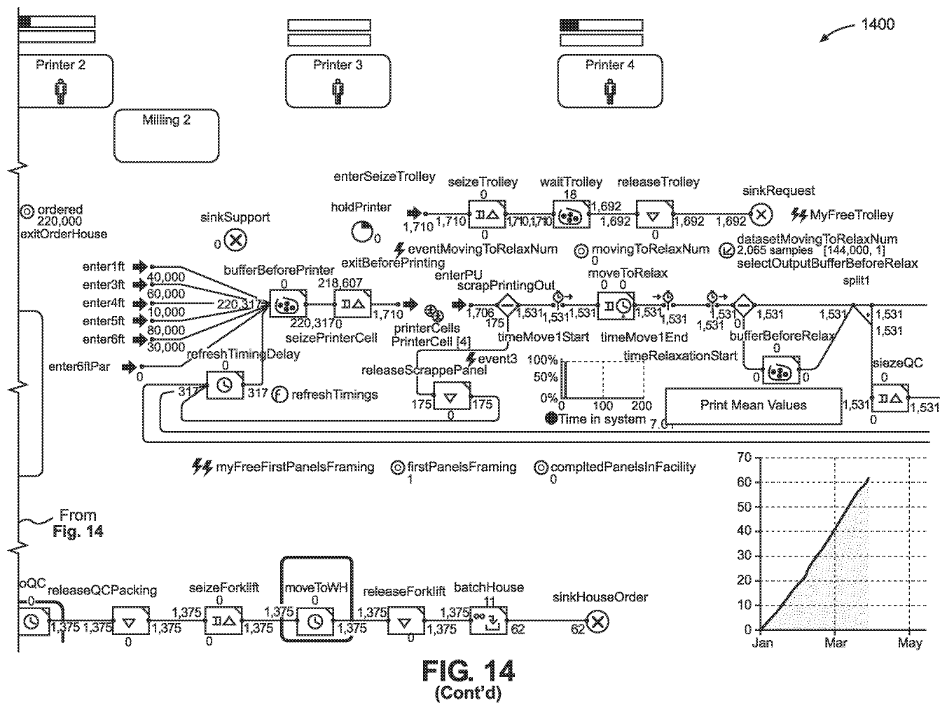

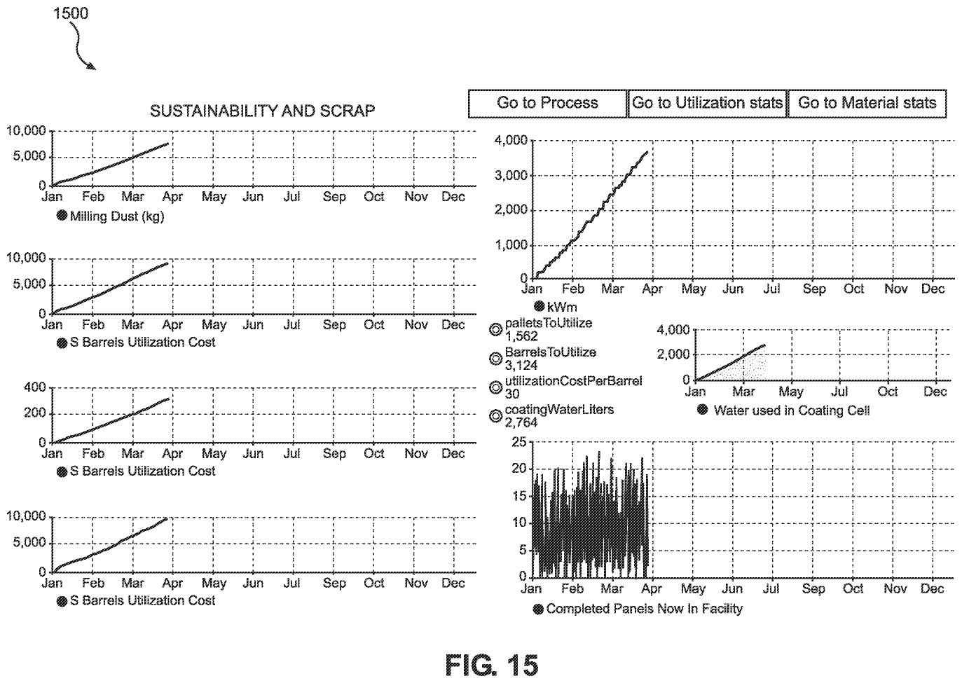

FIG. 14 illustrates a simulation model for a software simulation tool configured for identifying an optimal configuration of a production line. Simulation model 1400 can reflect the different types of 3D-printed building elements that are to be produced by a given configuration, as well as the different types and amounts of production stations and other system areas to be in use. Expected production flow patterns can be provided for one or more production lines, as well as details regarding these expected patterns. FIG. 15 illustrates a GUI for a software simulation tool configured to provide output regarding simulation of production line scenarios. GUI screen 1500 can depict a variety of different expected outputs in graphical and other formats, such as graphs regarding the monthly expected sustainability and scrap for a given production line configuration, as shown. Other outputs that can be similarly displayed in graphical or other formats, can include, for example, power consumption, recyclable waste amounts, rework amounts, materials requirements, labor requirements, and production throughputs, among other possible outputs.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A system for manufacturing 3D-printed building elements, the system comprising:
at least one printing station having a large-scale 3D-printing system configured to automatically form 3D-printed building elements;
at least one insulation station configured to automatically place one or more insulation materials into the 3D-printed building elements, wherein the at least one insulation station is further configured to receive the 3D-printed building elements in a vertical orientation from the at least one printing station;
at least one machining station configured to automatically machine one or more surfaces of the 3D-printed building elements to facilitate future coupling of the 3D-printed building elements to other building elements or building parts, wherein the at least one machining station is further configured to receive the 3D-printed building elements in a vertical orientation from the at least one printing station and from the at least one insulation station; and
at least one coating station configured to automatically apply one or more coating layers onto the 3D-printed building elements, wherein the at least one coating station is further configured to receive the 3D-printed building elements in a vertical orientation from the at least one printing station, from the at least one insulation station, and from the at least one machining station.

2. The system of claim 1, further comprising:
at least one relaxation station configured to automatically facilitate hardening of the 3D-printed building elements after the 3D-printing process, wherein the at least one relaxation station is further configured to receive the 3D-printed building elements in a vertical orientation from the at least one printing station.

3. The system of claim 1, further comprising:
at least one drying station configured to automatically facilitate drying of one or more coating layers applied by the at least one coating station to the 3D-printed building elements, wherein the at least one drying station is further configured to receive the 3D-printed building elements in a vertical orientation from the at least one coating station.

4. The system of claim 1, wherein the at least one coating station is further configured to automatically facilitate drying of one or more coating layers applied by the at least one coating station to the 3D-printed building elements.

5. The system of claim 1, wherein the system is contained within a manufacturing production line and the footprint of the manufacturing production line is less than about 15,000 square feet.

6. The system of claim 1, wherein each of the stations is further configured to perform its respective functions on the 3D-printed building elements while the 3D-printed building elements are in a vertical orientation.

7. The system of claim 1, wherein the at least one printing station includes a robotic subsystem configured to automatically 3D-print and cure base portions of the 3D-printed building elements layer-by-layer using a photo-curable material.

8. The system of claim 1, wherein the at least one insulation station includes a robotic subsystem configured to automatically inject polyurethane insulation foam into one or more cavities within the 3D-printed building elements.

9. The system of claim 1, wherein the at least one machining station includes a robotic subsystem configured to automatically machine the one or more surfaces of the 3D-printed building elements.

10. The system of claim 1, wherein the at least one coating station includes a robotic subsystem configured to automatically apply different types of coating materials onto the 3D-printed building elements.

11. The system of claim 1, wherein at least a portion of the stations are configured to have no more than one 3D-printed building element therein at a time.

12. The system of claim 1, wherein at least a portion of the stations are configured to have multiple 3D-printed building elements therein at a time.

13. The system of claim 1, wherein at least one of the stations has a longer production cycle than the production cycle of another one of the stations, and wherein the system includes multiple stations of the same type as the station having the longer production cycle.

14. The system of claim 1, wherein at least a portion of the stations use the same type of interchangeable robotic systems.

15. The system of claim 14, wherein a production process within the system can be changed by rerouting a production flow of the 3D-printed building elements through at least a portion of the stations using the same type of interchangeable robotic systems.

16. The system of claim 1, further comprising:
one or more scrap and rework stations configured for the scrapping and reworking of materials within the system.

17. The system of claim 1, wherein the scrapping and reworking of materials is configured to be handled outside of the system.

18. The system of claim 1, further comprising:
one or more automated guided vehicles configured to automatically move the 3D-printed building elements from one of the stations to another one of the stations.

19. The system of claim 18, wherein the one or more automated guided vehicles are further configured to be used as a printing base within the at least one printing station.

20. The system of claim 1, further comprising:
one or more framing stations configured for assembly of the 3D-printed building elements with additional building components.

21. The system of claim 1, wherein each of the stations is coupled to a separate control system and is configured to be managed by one or more production operators.

22. The system of claim 1, wherein all of the stations are coupled to a unified control system and the unified control system is configured to facilitate the supervision and control of all of the stations by one production operator.

23. The system of claim 1, wherein one or more of the stations are configured to read RFID tags to identify the 3D-printed building elements.

24. The system of claim 1, wherein the arrangement of the stations is configured by a separate CAD/CAE system where the 3D-printed building elements are designed.

25. The system of claim 1, further comprising:
one or more packaging stations configured for packaging the 3D-printed building elements when the 3D-printed building elements are finished.

26. The system of claim 1, where the system is configured to facilitate moving finished 3D-printed building elements to a separate packaging area outside of the system.

27. A method of producing a 3D-printed building element, the method comprising:
printing automatically a 3D-printed building element within a printing station having a large-scale 3D-printing system;
moving the 3D-printed building element into an insulation station;
placing automatically one or more insulation materials into the 3D-printed building element within the insulation station;
moving the 3D-printed building element into a machining station;
machining automatically one or more surfaces of the 3D-printed building element within the machining station;
moving the 3D-printed building element into a coating station;
applying automatically one or more coating layers onto the 3D-printed building element within the coating station; and
moving the 3D-printed building element out of the coating station.

28. The method of claim 27, further comprising the steps of:
moving the 3D-printed building element into a relaxation station; and
facilitating automatically hardening the 3D-printed building element within the relaxation station, wherein the facilitating occurs before moving the 3D-printed building element into the insulation station.

29. The method of claim 27, further comprising the steps of:
moving the 3D-printed building element into a drying station; and
facilitating automatically drying the one or more coating layers applied by the at least one coating station.

30. The method of claim 27, wherein each of the steps is performed while the 3D-printed building element is in a vertical orientation.

31. One or more non-transitory computer readable media including at least computer program code for simulating a production line for manufacturing 3D-printed building elements, the computer readable media comprising:
computer program code for accepting a plurality of inputs regarding desired production metrics for the production line for manufacturing 3D-printed building elements;
computer program code for analyzing the plurality of inputs using a known set of production line parameters; and
computer program code for providing an output that includes an optimal configuration of the production line and the potential maximum throughput of 3D-printed building elements manufactured by the production line, wherein the optimal configuration of the production line includes at least a required number of printing stations, a required number of insulation stations, a required number of machining stations, and a required number of coating stations.

32. The computer readable media of claim 31, wherein the optimal configuration of the production line further includes a required number of 3D-printed building element moving vehicles, a required number of 3D-printed building element stackers, a required number of quality engineers, a required number of general workers, a required number of worker shifts per day, a required amount of power consumption, an estimated amount of generated recycling, and an estimated amount of generated scrap.

33. The computer readable media of claim 31, wherein the plurality of inputs includes desired amounts of scrap percentage per station, rework percentage per produced 3D-printed building element, required time per produced 3D-printed building element, and maintenance downtime per station.

34. The computer readable media of claim 31, wherein the optimal configuration of the production line further includes an estimated carbon footprint per produced 3D-printed building element.

35. The computer readable media of claim 31, further comprising:
computer program code for providing an updated output based on an updated set of production line parameters, wherein the updated set of production line parameters include new equipment installed to the previous optimal configuration, fewer worker shifts than in the previous optimal configuration, different amounts of downtime per station than in the previous optimal configuration, one or more material shortages, or one or more economical metrics.

36. The computer readable media of claim 31, wherein the output includes information regarding costs to run the production line at different production capacities.
